(19) United States
(12) Patent Application Publication
(10) Pub. No.: US 2014/0369035 A1
(43) Pub. Date: Dec. 18, 2014

(54) Straight Tube Lamp and Luminaire

(71) Applicant: Toshiba Lighting & Technology Corporation, Yokosuka-shi (JP)

(72) Inventor: Manabu Kika, Yokosuka-shi (JP)

(73) Assignee: TOSHIBA LIGHTING & TECHNOLOGY CORPORATION, Yokosuka-shi (JP)

(21) Appl. No.: 14/144,754

(22) Filed: Dec. 31, 2013

(30) Foreign Application Priority Data
Jun. 12, 2013 (JP) 2013-124025

(51) Int. Cl. F21K 99/00

(52) U.S. Cl. CPC F21K 9/30; F21K 9/17
USPC 362/217.17

(57) ABSTRACT

According to one embodiment, a base of a straight tube lamp is made of a metal, and includes an attachment part, a base part, a pair of side parts and a coupling part. The base part and the pair of side parts are thicker than the attachment part and the coupling part. The attachment part is provided on other surface side of the board so that one surface side of the board faces an inner surface of a tube. The base part is formed along a longitudinal direction on the inner surface of the tube most distant from the attachment part in an opposite side to the one surface side of the board. The pair of side parts are provided at both sides of the attachment part in a short direction and protrude from the attachment part toward the one surface side of the board. The coupling part couples the base part and the attachment part or the pair of side parts.

### INCORPORATION BY REFERENCE

The present invention claims priority under 35 U.S.C. §119 to Japanese Patent Application No. 2013-124025 filed on Jun. 12, 2013. The content of the application is incorporated herein by reference in their entirety.

### FIELD

Embodiments described herein relate generally to a straight tube lamp including a semiconductor light-emitting element as a light source and a luminaire including the straight tube lamp.

### BACKGROUND

Hitherto, although a straight tube type fluorescent lamp is used for illumination of an office or the like, a straight tube type LED lamp including, as a light source, an LED, which has low power consumption and long life, becomes used. In the straight tube type LED lamp, a board on which the LED is mounted is attached to a metal base, and the base may be housed in a cylindrical outer tube. The base is formed into a column body including an arc-shaped surface along the inner surface of the outer tube and a flat attachment surface to which the board is attached, and is made of a metal having high heat conductivity, for example, aluminum. Since the base is formed into the column body (lump), the base has some rigidity and has some weight.

In the straight tube type LED lamp, even if the base has rigidity, the base is liable to bend (warp) in a longitudinal direction by its own weight, and as the whole length thereof becomes long, the base is more liable to bend. Besides, since the straight tube type LED lamp includes the base, the weight is considerable, and as the whole length becomes long, the weight becomes heavy. If the straight tube type LED lamp is lightweight, handling is easy, and reduction of weight is desired. Besides, since aluminum forming the base is a relatively expensive metal, reduction of the amount of formation and reduction of weight of the base are desired also from the viewpoint of cost reduction of the straight tube type LED lamp and resource saving.

In order to reduce the amount of formation and to reduce the weight of the base, it is conceivable to provide a through-hole or a hollow part in the longitudinal direction. Besides, it is conceivable that the base is made of a relatively lightweight synthetic resin, for example, polycarbonate resin.

However, although the weight of the base merely provided with the hollow part or the like is reduced, there is a problem that the rigidity is reduced. Thus, in the straight tube type LED lamp in which the base is housed in a resin outer tube, similarly to the case of the base formed into the column body (lump), the base is liable to bend (warp) in the longitudinal direction by the weight of the outer tube and the base, and there is a problem that a board on which an LED is mounted also bends (warps) in the longitudinal direction.

Besides, the rigidity of the resin base is low as compared with the metal base, and similarly to the case of the metal base, there is a problem that the base is liable to bend in the longitudinal direction. Besides, the heat conductivity of the resin base is low as compared with the metal base, and there is a problem that thermal radiation performance of radiating the heat from the LED is reduced.

### BRIEF DESCRIPTION OF THE DRAWINGS

FIG. 1 is a schematic plan view of a straight tube lamp of a first embodiment in which a tube is seen through.

FIG. 2 is a schematic vertical sectional view of the straight tube lamp.

FIG. 3 is a schematic vertical sectional view of a straight tube lamp of a second embodiment.

FIGS. 4A to 4D are schematic vertical sectional views of straight tube lamps of a third embodiment.

FIG. 5 is a schematic perspective view of a luminaire of a fourth embodiment.

### DETAILED DESCRIPTION

In general, according to one embodiment, a straight tube lamp including a resin outer tube in which bending in a longitudinal direction is suppressed, and a luminaire including the straight tube lamp are provided.

That is, the straight tube lamp of one embodiment includes a tube, a luminous body, a base and a cap.

The tube is formed into a straight tube shape having translucency.

The luminous body includes a long board and a semiconductor light-emitting element. The semiconductor light-emitting element is disposed on one surface side of the board along a longitudinal direction.

The base is made of a metal, and includes an attachment part, a base part, a pair of side parts and a coupling part. The base part and the pair of side parts are formed to be thicker than the attachment part and the coupling part. The attachment part is disposed on the other surface side of the board so that the one surface side of the board faces an inner surface of the tube. The base part is formed along a longitudinal direction on the inner surface of the tube most distant from the attachment part in an opposite side to the one surface side of the board. The pair of side parts is formed at both sides of the attachment part in a short direction and protrudes from the attachment part toward the one surface side of the board. The coupling part couples the base part and the attachment part or the pair of side parts. The coupling part causes the attachment part to be located at a specified position in the tube.

The cap is provided at an end of the tube, and includes a power-supply contact connected to the semiconductor light-emitting element.

According to the straight tube lamp of the embodiment, since the base part and the pair of side parts are located at most distant positions from each other and are respectively formed to be thick, the parts have rigidity to resist the weight of the tube and the base. Thus, even if the attachment part and the coupling part are formed to be thin and the base is formed to be lightweight, it can be expected that bending in the longitudinal direction is suppressed.

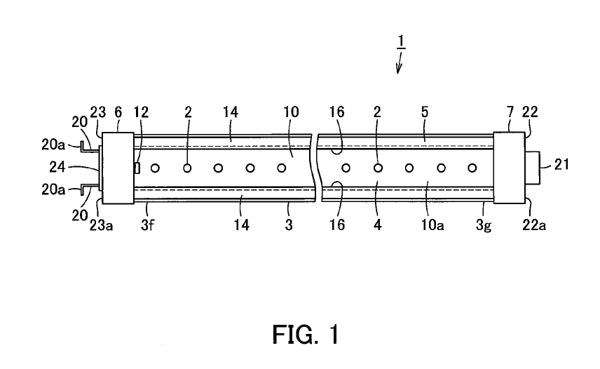

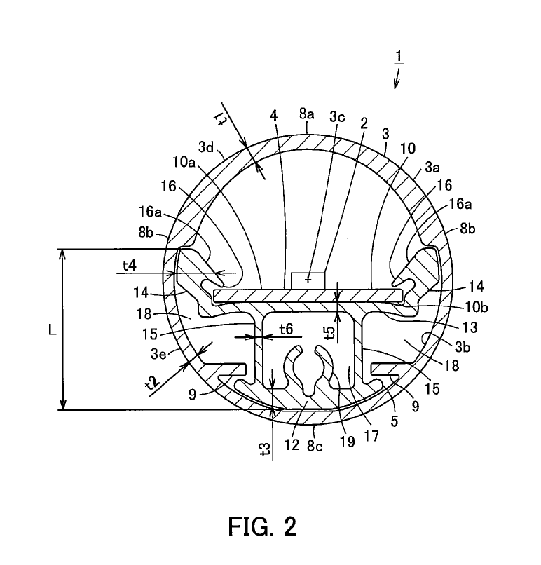

Hereinafter, embodiments will be described with reference to the drawings. First, a first embodiment will be described with reference to FIG. 1 and FIG. 2.

A straight tube lamp 1 of this embodiment is constructed as shown in FIG. 1 and FIG. 2. In FIG. 1, the straight tube lamp 1 is a straight tube type LED lamp in which an LED element 2 as a semiconductor light-emitting element is a light source, and includes a tube 3, a luminous body 4, a base 5 and caps 6 and 7. Incidentally, in FIG. 2, the caps 6 and 7 are omitted.

The tube 3 is made of a translucent synthetic resin, for example, polycarbonate (PC) resin, and is formed into a straight tube shape having an outer diameter of, for example, 25 mm. A light diffusing agent is mixed in the polycarbonate (PC) resin.

In this embodiment, as shown in FIG. 2, in a longitudinal section, the tube 3 is such that an outer surface 3a is formed into a circular shape, and an inner surface 3b is formed into a specified shape. That is, in FIG. 2, over the longitudinal direction of the tube 3, a thickness t1 of one end side portion 3d extending from a top 8a to parts 8b and 8b close to a center axis 3c of the tube 3 becomes gradually thick within a range of, for example, from 1.0 mm to 2.0 mm. Besides, a thickness t2 of the other end side portion 3e extending from the parts 8b and 8b to a bottom 8c is formed to be substantially constant, for example, 0.8 mm. Besides, a pair of protrusions 9 and 9 protruding by a specified length so as to confront each other is provided on the inner surface 3b at the bottom 8c side of the other end side portion 3e over the longitudinal direction of the tube 3. The tube 3 is formed by, for example, extrusion molding.

In the tube 3, the luminous body 4 is arranged in the vicinity of the center axis 3c so that the LED element 2 is directed to the top 8a side. The pair of protrusions 9 and 9 is provided to prevent the tube 3 provided to be held between the caps 6 and 7 from rotating. When the tube rotates around the center axis 3c, the protrusions contact the base 5. Besides, the pair of protrusions 9 and 9 functions as a rail for inserting the base 5 into the tube 3.

The luminous body 4 is formed to include a board 10 and the plurality of LED elements 2 as semiconductor light-emitting elements. The board 10 is made of a synthetic resin plate having insulation properties, for example, a glass epoxy plate or a ceramic plate, and is formed into a long rectangle. The LED elements 2 are mounted on one surface 10a of the board 10, and are, as shown in FIG. 1, provided at equal intervals along the longitudinal direction of the board 10 and in one line in this embodiment.

The LED elements 2 are connected in series-parallel by a not-shown wiring pattern. The series-parallel connected LED elements 2 are connected to a connector 12 provided on one end side of the board 10 by the not-shown wiring pattern. The LED element 2 is a package product, and for example, one emitting white light is used. Incidentally, a plurality of the luminous bodies 4 is used according to the whole length of the tube 3.

The base 5 is provided in the tube 3 so that the luminous body 4 is arranged at a specified position in the tube 3. As shown in FIG. 2, the base 5 is formed to include a base part 12, an attachment part 13, a pair of side parts 14 and 14 and coupling parts 15 and 15. The base 5 is made of a metal material having high heat conductivity, for example, aluminum (Al), and is molded by, for example, extrusion molding.

The base part 12 is formed into a column body having a substantially arc-shaped section to contact the inner surface 3b of the tube 3 along the longitudinal direction of the tube 3, so that the whole base 5 can be supported by the inner surface 3b of the tube 3. Besides, the base part 12 is perpendicular to the attachment part 13 and is formed along the longitudinal direction on the inner surface 3b of the tube 3 most distant from the attachment part 13 in the opposite side to the one surface 10a side of the board 10. Besides, the base part 12 is formed to be arranged in the tube 3 on the side closer to the bottom 8c than the pair of protrusions 9 and 9.

The attachment part 13 is formed into a substantially flat shape having a flat attachment surface on which the other surface 10b side of the board 10 of the luminous body 4 is provided. The attachment part 13 is provided to be substantially parallel to the base part 12, and is provided so that a virtual surface perpendicular to the center in the short direction of the attachment part becomes the same surface as a virtual surface perpendicular to the center in the short direction of the base part 12. That is, the attachment part 13 is provided in such a positional relation that the base part 12 is perpendicular to the attachment part 13 and is provided on the inner surface 3b of the tube 3 most distant from the attachment part 13 in the opposite side to the one surface 10a side of the board 10. The pair of side parts 14 and 14 are integrally formed on both sides of the attachment part 13 in the short direction.

The pair of side parts 14 and 14 protrudes from the attachment part 13 to the one surface 10a side of the board 10, and is provided on both sides of the board 10 in the short direction. Besides, the pair of side parts 14 and 14 is provided to contact the inner surface 3b of the tube 3 on the side closer to the top 8a than the attachment part 13. Since the base part 12 is perpendicular to the attachment part 13 and is provided on the inner surface 3b of the tube 3 most distant from the attachment part 13 in the opposite side to the one surface 10a side of the board 10, the pair of side parts 14 and 14 is provided at positions most distant from the base part 12.

The pair of side parts 14 and 14 is provided with pawl parts 16 and 16 formed so as to hold both the ends of the board 10 in the short direction between themselves and the attachment part 13. The pawl parts 16 and 16 include reflection surfaces 16a and 16a as surfaces to which white light emitted from the LED elements 2 is irradiated. The reflection surfaces 16a and 16a are formed to smoothly extend from the one surface 10a side of the board 10 to the inner surface 3b side of the tube 3. Besides, the pawl parts 16 and 16 are formed to contact or to be close to both the ends in the short direction on the one surface 10a side of the board 10, and fix or substantially fix the luminous body 4 to the attachment part 13.

The coupling parts 15 and 15 are for coupling the attachment part 13 to the base part 12 so that the luminous body 4 is arranged at a specified position in the tube 3. That is, in this embodiment, the attachment part 13 is provided to be located at a specified position in the tube 3, and the luminous body 4 is positioned in the vicinity of the center axis 3c of the tube 3 and to be closer to the bottom part 8c side than the center axis 3c. Since the luminous body 4 is provided to be distant from the top 8a of the tube 3, white light emitted from the LED elements 2 exits from the outer surface 3a of the tube 3 to obtain wide luminous intensity distribution, and grain feeling due to the LED elements 2 is hard to occur on the outer surface 3a on the top 8a side.

The coupling parts 15 and 15 are respectively formed into thin flat plate shapes, and couple the base part 12 and the attachment part 13 so that a space 17 and spaces 18 and 18 are formed between the attachment part 13, the pair of side parts 14 and 14 and the base part 12. The space 17 is formed of a through hole in the longitudinal direction, and the spaces 18 and 18 are formed of concave grooves in the longitudinal direction.

In the base 5, the base part 12 and the pair of side parts 14 and 14 are formed to be thicker than the attachment part 13 and the coupling parts 15 and 15. In this embodiment, a thickness t3 of the base part 12 and a thickness t4 of the pair of side parts 14 and 14 are 1.5 or more times larger than a thickness t5 of the attachment part 13 and a thickness t6 of the coupling parts 15 and 15. Here, each of the thicknesses t3 to t6 to be compared may be any of a maximum thickness, a minimum thickness, an average thickness and a thickness of a main part. In other words, the base part 12 and the pair of side parts 14 and 14 are formed to be thicker than the attachment part 13 and the coupling parts 15 and 15 in cross-sectional area perpendicular to the longitudinal direction.

Besides, in the base 5, a C-shaped rib 19 protruding toward the space 17 is provided on the base part 12 along the longitudinal direction. The rib 19 is for fixing the caps 6 and 7 to both ends of the base 5 in the longitudinal direction by self-tapping screws.

In FIG. 1, the caps 6 and 7 are respectively provided at both ends 3f and 3g of the tube 3 in the longitudinal direction. Each of the caps 6 and 7 is a cap in compliance with the GX16t-5 standard stipulated by JAPAN LIGHTING LAMP MANUFACTURERS ASSOCIATION, and is formed of a synthetic resin having electrical insulation properties, for example, polybutylene terephthalate (PBT) into a cylindrical shape with a bottom. Both the ends 3f and 3g of the tube 3 in the longitudinal direction are inserted in the caps 6 and 7. The caps 6 and 7 are fixed to the base 5 by screwing not-shown self-tapping screws in the rib 19 of the base 5.

The cap 6 is a power-supply terminal side cap and is provided with a pair of power-supply contacts 20 and 20. The cap 7 is an earth terminal side cap and is provided with one holder 21. The pair of power-supply contacts 20 and 20 is made of, for example, brass, and is formed into substantially plate shapes having a relatively large thickness. The holder 21 is formed into a rectangular parallelepiped and is provided at the center of an outer surface 22a of a bottom 22 of the cap 7. That is, the holder 21 is formed integrally with the cap 7 and protrudes from the outer surface 22a of the bottom 22.

A flat convex part 24 is provided on an outer surface 23a of a bottom 23 of the cap 6. The convex part 24 is formed into a substantially rectangular shape and is provided at the center of the outer surface 23a. The pair of power-supply contacts 20 and 20 is provided by insert molding, and pass through the bottom 23 of the cap 6 and the convex part 24. Besides, the pair of power-supply contacts 20 and 20 is attached to the convex part 24 such that tip sides 20a and 20a are bent into an L-shape and in a direction away from each other. The pair of power-supply contacts 20 and 20 is connected to the connector 12 disposed on the board 10 by a not-shown connection line wired in the cap 6 and the tube 3.

The pair of protrusions 9 and 9 provided on the inner surface 3b collides with the coupling parts 15 and 15 of the base 5 or the base part 12, so that the rotation of the tube 3 is regulated. In the straight tube lamp 1 constructed as described above, the cap 6 and the cap 7 are attached to a power supply socket and a holding socket of a luminaire.

Next, the operation of the first embodiment will be described.

In the straight tube lamp 1, when specified power (constant current) is supplied to the pair of power-supply contacts 20 and 20 of the cap 6, the plurality of LED elements 2 of the luminous body 4 are lit (emit light), and white light is emitted from the LED elements 2. The white light is directly incident on the one end side portion 3d of the tube 3. Besides, partial spreading light of the white light is incident on the reflection surfaces 16a and 16a of the pawl parts 16 and 16 provided on the pair of side parts 14 and 14 of the base 5. Since the reflection surfaces 16a and 16a are formed to extend from the one surface 10a side of the board 10 to the inner surface 3b side of the tube 3, the white light incident on the reflection surfaces 16a and 16a is almost incident on the one end side portion 3d of the tube 3. That is, the white light emitted from the LED elements 2 is not shielded by the pair of side parts 14 and 14, but is incident on the one end side portion 3d of the tube 3 in a state where optical loss is low.

The white light is diffused inside the one end side portion 3d of the tube 3, passes through the tube 3 and is emitted to the external space. Since the white light is diffused and is emitted, the light emission of each of the LED elements 2 is hard to be seen from the outside of the tube 3, and the tube 3 appears to emit light substantially uniformly in the longitudinal direction. Besides, since the luminous body 4 is arranged to be closer to the bottom 8c side than the center axis 3c of the tube 3, the light emission of each of the LED elements 2 is hard to be seen from the outside of the tube 3.

It is assumed that the straight tube lamp 1 is attached to the luminaire in such a manner that the luminous body 4 is directed downward (floor side). In the straight tube lamp 1, since the caps 6 and 7 are attached to the power supply socket and the holding socket of the luminaire, the weights of the tube 3 and the base 5 act downward (floor side) while the power supply socket and the holding socket are fulcrums. Especially, the action of the weights is great at the center of the tube 3 in the longitudinal direction.

The weight of the tube is operated on the whole base 5 from the base part 12 of the base 5. The base 5 is operated and deformed by the weights of the tube 3 and the base 5. Here, stress in a direction perpendicular to the longitudinal direction, that is, the stress in the direction perpendicular to the attachment part 13, which is the stress exerted on the straight tube lamp 1 of this embodiment, is generated especially between members most distant from each other in the deformation direction. That is, the stress perpendicular to the longitudinal direction is most significantly generated in the base part 12 and the pair of side parts 14 and 14.

The metal forming the base 5, for example, aluminum is a rigid body, and it is obvious that as the thickness becomes large, the rigidity becomes high. However, if the thickness is made large in order to suppress the deformation, the weight becomes heavy, and the deformation due to the weight becomes large. At this time, the amount of deformation due to the weight of the base 5 can be suppressed as a distance L in the deformation direction between the base part 12 and the pair of side parts 14 and 14 becomes large, and as the rigidity at the most distant position in the deformation direction becomes high. That is, the distance L can be increased by forming the pair of side parts 14 and 14 on the one surface 10a side of the board 10, not on the attachment part 13. Further, the rigidity at the most distant position in the deformation direction can be increased by increasing the thicknesses of the pair of side parts 14 and 14 and the base part 12.

At the time of deformation of the base 5, since the stress to the attachment part 13 and the coupling parts 15 and 15 is low, it is confirmed that if the attachment part 13 and the coupling parts 15 and 15 respectively have a certain degree of thickness, even if they are formed to be thin, the deformation is hard to occur. That is, it is confirmed that if the minimum thickness of the thin portion is 0.6 mm or more, the deformation is hard to occur.

Besides, if the straight tube lamp 1 is attached to the luminaire such that the luminous body 4 is directed upward (ceiling side), the weights of the tube 3 and the base 5 act on the whole base 5 from the pair of side parts 14 and 14. The weights of the tube 3 and the base 5 act on the pair of side parts 14 and 14 and the base part 12 of the base 5, and the pair of side parts 14 and 14 and the base part 12 resist against the weights. Since the base part 12 and the pair of side parts 14 and 14 are located at the most distant positions from each other, and are formed to be thick, the rigidity of the base 5 is increased. By this, the base 5 is hard to be deformed by the weights of the tube 3 and the base 5.

As described above, the pair of side parts 14 and 14 are formed at the positions most distant from the base part 12 in the deformation direction, and the base part 12 and the pair of side parts 14 and 14 are respectively formed to be thick and have the rigidity to the weights of the tube 3 and the base 5. Accordingly, the whole base 5 is hard to deform. By this, the bending (warp) of the base 5 and the tube 3 in the longitudinal direction is suppressed. Since the base 5 is not bent in the longitudinal direction, the bending (warp) of the board 10 of the luminous body 4 in the longitudinal direction is also suppressed.

Since the base 5 includes the space 17 and the spaces 18 and 18 between the base part 12, the attachment part 13 and the pair of side parts 14 and 14, and the attachment part 13 and the coupling parts 15 and 15 are formed to be thin, the weight of the base is reduced. Accordingly, the weight of the straight tube lamp 1 is reduced. The straight tube lamp 1 whose weight is reduced is easily handled and attached to the luminaire.

According to this embodiment, since the base part 12 and the pair of side parts 14 and 14 are located at the most distant positions from each other and are formed to be thick, the base 5 has the rigidity to the weights of the tube 3 and the base 5. Thus, even if the attachment part 13 and the coupling parts 15 and 15 are formed to be thin and the weight is reduced, the bending in the longitudinal direction can be suppressed. By this, there is an effect that the weight of the straight tube lamp 1 can be reduced, and the bending in the longitudinal direction by the weight can also be suppressed.

Besides, the pair of side parts 14 and 14 of the base 5 include the pawl parts 16 and 16 formed to hold both the ends of the board 10 in the short direction between themselves and the attachment part 13, and the reflection surfaces 16a and 16a of the pawl parts 16 and 16 are formed to extend from the one surface 10a side of the board 10 to the inner surface 3b of the tube 3. Thus, there is an effect that the luminous body 4 can be fixed or temporarily fixed to the base 5 by the simple structure, the light loss of the white light emitted from the LED elements 2 is reduced, and the wide luminous intensity distribution can be obtained.

Incidentally, in this embodiment, although the LED element 2 is used as the semiconductor light-emitting element in the luminous body 4, no limitation is made to this. An LED chip may be provided on the board 10 by a COB (Chip On Board) system. Besides, an organic electro luminescence (EL) element may be used as the semiconductor light-emitting element.

Next, a second embodiment will be described.

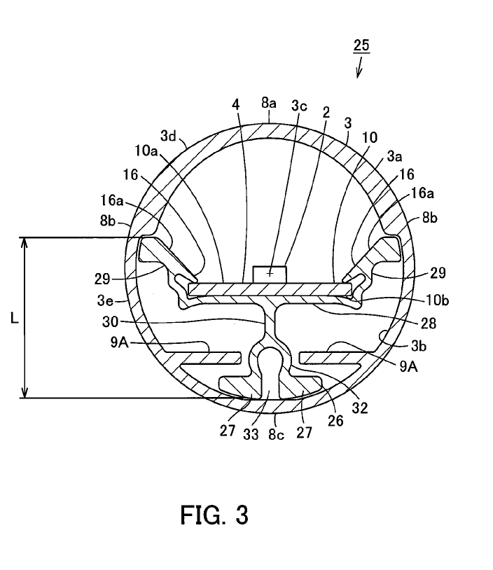

FIG. 3 is a schematic vertical sectional view showing a straight tube lamp 25 of this embodiment. Incidentally, portions identical to or similar to those of FIG. 2 are denoted by the same reference numerals and their explanation is omitted.

The straight tube lamp 25 is such that in the straight tube lamp 1 shown in FIG. 2, a base 26 is provided instead of the base 5. Similarly to the base 5, the base 26 is made of a metal material having high heat conductivity, for example, aluminum (Al), is formed by, for example, die-cast, and includes base parts 27 and 27, an attachment part 28, a pair of side parts 29 and 29 and a coupling part 30.

The attachment part 28 is formed into a substantially flat plate shape thinner than the attachment part 13. Although the pair of side parts 29 and 29 is formed to be partially thinner than the pair of side parts 14 and 14, they are formed to be thicker than the attachment part 28 and the coupling part 30. Besides, similarly to the pair of side parts 14 and 14, the pair of side parts 29 and 29 includes pawl parts 16 and 16 and reflection surfaces 16a and 16a to which emitted light (white light) from LED elements 2 is irradiated.

The one coupling part 30 is provided, and the coupling part 15 and the C-shaped rib 19 shown in FIG. 2 are united and are formed to be thin. The base parts 27 and 27 are formed to be coupled to tips of a C-shaped rib part 32 of the coupling part 30, and are provided on an inner surface 3b of a tube 3 along a longitudinal direction. The base parts 27 and 27 are formed into substantially arc-shaped thick column bodies along the inner surface 3b of the tube 3, and a gap 33 of a specified width is provided between the base parts and communicates with the inside of the rib part 32. The rib part 32 is for fixing the caps 6 and 7 by self-tapping screws at both ends of the base 26 in the longitudinal direction.

The coupling part 30 is formed to extend in a direction perpendicular to a short direction from the center of the attachment part 28 in the short direction. Further, the base parts 27 and 27 are perpendicular to the attachment part 28 and are formed to be provided on the inner surface 3b of the tube 3 most distant from the attachment part 28 in the opposite side to a one surface 10a side of the board 10. By this, in the base 26, a distance L between the base parts 27 and 27 and the pair of side parts 29 and 29 can be increased. Since the one coupling part 30 is formed to be thin, the base 26 is more lightweight than the base 5 shown in FIG. 2.

Since the pair of side parts 29 and 29 and the base parts 27 and 27 are located at most distant positions from each other, and are respectively formed to be thick, even if the weight of the base 26 is reduced, the base has rigidity to the weights of the tube 3 and the base 26, and is hard to deform. By this, the bending of the straight tube lamp 25 in the longitudinal direction can be suppressed. Besides, the weight of the straight tube lamp is reduced by the reduction of the weight of the base 26, handling such as carrying or attaching is facilitated.

Incidentally, similarly to FIG. 2, protrusions 9A and 9A are provided on the inner surface 3b of the tube 3. The protrusions 9A and 9A are formed to be close to the rib part 32 of the coupling part 30 of the base 26. When the tube 3 rotates, the rib part 32 collides with the protrusions 9A and 9A, and consequently, the rotation is blocked.

Next, a third embodiment will be described.

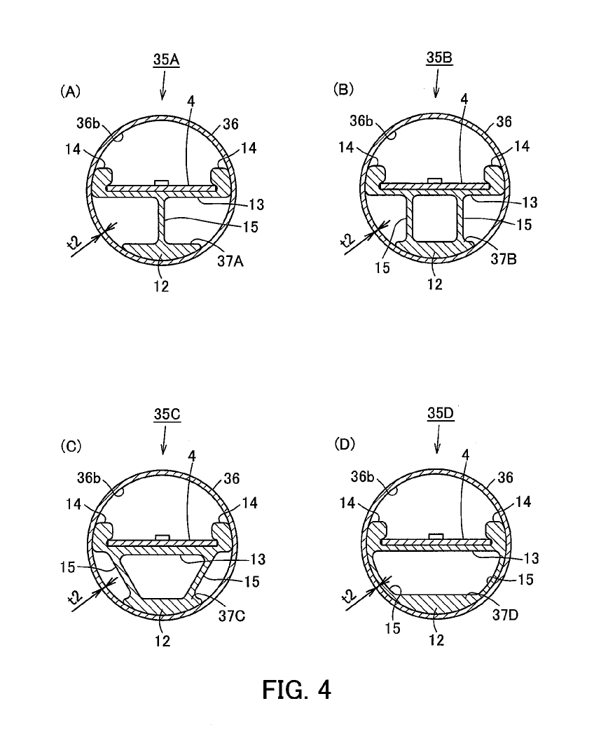

FIG. 4A to FIG. 4D are schematic vertical sectional views showing straight tube lamp 35A to 35D of this embodiment. Incidentally, portions identical to or similar to those of FIG. 2 are denoted by the same reference numerals and their explanation is omitted.

In the straight tube lamps 35A to 35D, a tube 36 is similar to the tube 3 shown in FIG. 2 except that the tube is formed into a cylindrical shape having a constant thickness t2, for example, 0.8 mm. The straight tube lamps 35A to 35D are formed similarly to the straight tube lamp 1 shown in FIG. 1 except that structures of bases 37A to 37D are different.

The bases 37A to 37D are generally different from each other in structure of a coupling part 15. A pair of side parts 14 and 14 is formed into a substantially rectangular parallelepiped shape in close contact with an inner surface 36b of the tube 36.

The base 37A is such that a base part 12 and an attachment part 13 are coupled by one coupling part 15. The bases 37B and 37C are such that a base part 12 and an attachment part 13 are coupled by two coupling parts 15. In the base 37B, the coupling parts 15 and 15 are provided to be parallel to each other. In the base 37C, the coupling parts 15 and 15 are provided so as to spread. The base 37D is such that coupling parts 15 and 15 are formed into arc shapes in close contact with the inner surface 36b of the tube 36, and couple the base part 12 and the pair of side parts 14 and 14. As indicated by the bases 37A to 37D, the coupling part 15 couples the base part 12 and the attachment part 13 or the pair of side parts 14 and 14.

The bases 37A to 37D have considerable rigidity since the base part 12 and the pair of side parts 14 and 14 are located at most distant positions from each other and are respectively formed to be thick. Thus, although the weight is reduced, by the same action as the base 5 described in FIG. 2, the base is hard to be deformed by the weights of the bases 37A to 37D and the tube 36. Accordingly, the straight tube lamps 35A to 35D have an effect that the bending of the tube 36 and the bases 37A to 37D in the longitudinal direction can be suppressed, and handling is facilitated by the reduction of weight.

Next, a fourth embodiment will be described.

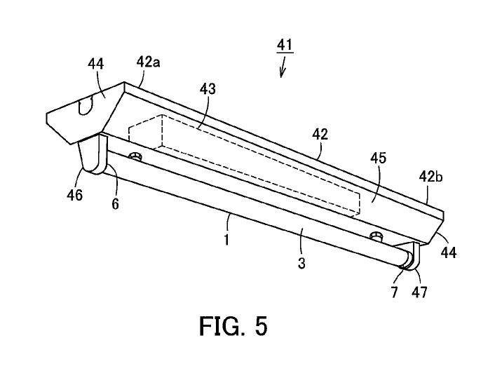

FIG. 5 shows a luminaire 41 of this embodiment. The luminaire 41 is a base light directly attached to a ceiling surface, and includes an equipment main body 42, the straight tube lamp 1 shown in FIG. 1, and a lighting circuit 43. The equipment main body 42 is made of, for example, a cold-rolled steel plate, and is formed into a rectangular box body including end plates 44 and 44 and a reflection plate 45. A pair of sockets 46 and 47 to which the straight tube lamp 1 is detachably attached is attached to both end sides 42a and 42b of the equipment main body 42 in the longitudinal direction. The lighting circuit 42 is provided inside the equipment main body 42.

The caps 6 and 7 of the straight tube lamp 1 are inserted and connected to the pair of sockets 46 and 47. The socket 46 is a power supply socket, and the socket 47 is a holding socket. The lighting circuit 43 supplies a constant current to the straight tube lamp 1, and is formed so as to light the straight tube lamp 1.

According to the luminaire 41 of this embodiment, in the straight tube lamp 1, since the bending (warp) of the tube 3 in the longitudinal direction is suppressed, there is an effect that stable illumination can be performed without impairing the outer appearance.

Incidentally, the luminaire 41 of the embodiment is not limited to the ceiling mounting type, but may be an embedded type or hanging type luminaire.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A straight tube lamp comprising:
a straight tube having translucency;
a luminous body including a board and a semiconductor light-emitting element disposed on one surface side of the board along a longitudinal direction;
a metal base including an attachment part which is disposed on other surface side of the board to cause the one surface side of the board to face an inner surface of the tube, a base part which is formed along a longitudinal direction on the inner surface of the tube most distant from the attachment part in an opposite side to the one surface side of the board, a pair of side parts which is formed at both sides of the attachment part in a short direction and protrude from the attachment part toward the one surface side of the board, and a coupling part which couples the base part and one of the attachment part and the pair of side parts, in which the base part and the pair of side parts are thicker than the attachment part and the coupling part; and
a cap which includes a power-supply contact connected to the semiconductor light-emitting element and is provided at an end of the tube.

2. The lamp according to claim 1, wherein in the base, the base part and the pair of side parts are located at most distant positions from each other.

3. The lamp according to claim 1, wherein the pair of side parts is formed so as to sandwich both ends of the board in the short direction between themselves and the attachment part, and surfaces to which light from the semiconductor light-emitting element is irradiated are formed so as to extend from the one surface side of the board to the inner surface side of the tube.

4. The lamp according to claim 1, wherein a protrusion is provided on the inner surface of the tube to regulate rotation of the base with respect to the tube by contact with the coupling part or the base part.

5. The lamp according to claim 1, wherein the base includes spaces formed between the base part, the attachment part and the pair of side parts.

6. The lamp according to claim 1, wherein thicknesses of the base part and the pair of side parts are 1.5 times or more larger than those of the attachment part and the coupling part.

7. A luminaire comprising:
a straight tube lamp including: a straight tube having translucency; a luminous body including a board and a semiconductor light-emitting element disposed on one surface side of the board along a longitudinal direction; a metal base including an attachment part which is disposed on other surface side of the board to cause the one surface side of the board to face an inner surface of the tube, a base part which is formed along a longitudinal direction on the inner surface of the tube most distant from the attachment part in an opposite side to the one surface side of the board, a pair of side parts which are provided at both sides of the attachment part in a short direction and protrude from the attachment part toward the one surface side of the board, and a coupling part which couples the base part and one of the attachment part and the pair of side parts, in which the base part and the pair of side parts are thicker than the attachment part and the coupling part; and a cap which includes a power-supply contact connected to the semiconductor light-emitting element and is disposed at an end of the tube;
an equipment main body including a socket to which the cap of the straight tube lamp is connected; and
a lighting circuit to light the straight tube lamp.

8. The luminaire according to claim 7, wherein in the base, the base part and the pair of side parts are formed at most distant positions from each other.

9. The luminaire according to claim 7, wherein the pair of side parts hold both ends of the board in the short direction between themselves and the attachment part, and surfaces to which light from the semiconductor light-emitting element is irradiated extend from the one surface side of the board to the inner surface side of the tube.

10. The luminaire according to claim 7, wherein a protrusion is provided on the inner surface of the tube to regulate rotation of the base with respect to the tube by contact with one of the coupling part and the base part.

11. The luminaire according to claim 7, wherein the base includes spaces between the base part, the attachment part and the pair of side parts.

12. The luminaire according to claim 7, wherein thicknesses of the base part and the pair of side parts are 1.5 times or more larger than those of the attachment part and the coupling part.
